(19) United States
(12) Patent Application Publication
(10) Pub. No.: US 2006/0153055 A1
(43) Pub. Date: Jul. 13, 2006

(54) Recording medium, and method and apparatus for recording data in the recording medium

(76) Inventor: Sang Woon Suh, Seoul (KR)

Correspondence Address: HARNESS, DICKEY & PIERCE, P.L.C., P.O. BOX 8910, RESTON, VA, 20195, US

(21) Appl. No.: 11/328,069

(22) Filed: Jan. 10, 2006

(30) Foreign Application Priority Data
Jan. 12, 2005 (KR) 10-2005-0002892

(51) Int. Cl. G11B 7/24; G11B 5/09

(52) U.S. Cl. 369/275.1; 369/47.5

(57) ABSTRACT

A recording medium, and a method and apparatus for recording data in the recording medium are disclosed. The recording medium including at least two record layers, each of which includes an inner area, a data area, and an outer area, includes; at least one Optimum Power Control (OPC) area contained in at least one of the inner and outer areas, wherein respective OPC areas contained in neighboring record layers are not arranged at the physically same positions with respect to optical beam. Therefore, data can be effectively recorded in the recording medium.

This application claims the benefit of Korean Patent Application No. 10-2005-0002892, filed on, Jan. 12, 2005, which is hereby incorporated by reference as if fully set forth herein.

### BACKGROUND OF THE INVENTION

1. Field of the Invention

The present invention relates to a recording medium, and more particularly to a physical structure, and a method and apparatus for recording data in the recording medium using the physical structure.

2. Discussion of the Related Art

Generally, there has been widely used an optical disc acting as a recording medium capable of recording a large amount of data therein. Particularly, there has recently been developed a high-density optical recording medium capable of recording/storing high-quality video data and high-quality audio data for a long period of time, for example, a Blu-ray Disc (BD).

The BD based on the next-generation recording medium technique has been considered to be the next-generation optical recording solution capable of storing much more data than a conventional DVD. In recent times, many developers have conducted intensive research into the international standard technical specification associated with the BD along with those of other digital devices.

However, a preferred physical structure for use in the BD has not yet been established, such that many limitations and problems occur in developing a BD-based optical recording/reproducing device.

### SUMMARY OF THE INVENTION

Accordingly, the present invention is directed to a recording medium, and a method and apparatus for recording data in the recording medium that substantially obviate one or more problems due to limitations and disadvantages of the related art.

An object of the present invention is to provide a physical structure suitable for a recording medium, and a method and apparatus for recording data in the recording medium using the physical structure.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a recording medium including at least two record layers, each of which includes an inner area, a data area, and an outer area, comprises; at least one Optimum Power Control (OPC) area contained in at least one of the inner and outer areas, wherein respective OPC areas contained in neighboring record layers are not arranged at the physically same positions with respect to optical beam.

In another aspect of the present invention, there is provided a method for recording data in a recording medium including a plurality of record layers comprising the steps of: a) reading position information of Optimum Power Control (OPC) areas, which are assigned to respective record layers contained in the recording medium such that some OPC areas of neighboring record layers are not arranged at the physically same positions with respect to optical beam; b) performing an OPC process to calculate an optimum record power in an OPC area confirmed by the read position information; and c) recording data in the recording medium using the calculated optimum record power.

In yet another aspect of the present invention, there is provided a method for establishing an Optimum Power Control (OPC) area of a recording medium including a plurality of record layers comprising the steps of: a) receiving a command for establishing OPC areas, assigning respective OPC areas to respective record layers contained in the recording medium, and establishing some OPC areas of neighboring record layers such that they are not arranged at the physically same positions with respect to optical beam; and b) recording available position information of the OPC areas of respective established record layers in a management area.

In yet another aspect of the present invention, there is provided an apparatus for recording data in a recording medium including a plurality of record layers comprising: a controller for transmitting a record command; and a recording/reproducing unit for reading position information of Optimum Power Control (OPC) areas, which are assigned to respective record layers contained in the recording medium such that some OPC areas of neighboring record layers are not arranged at the physically same positions with respect to optical beam; performing an OPC process to calculate an optimum record power in an OPC area confirmed by the read position information; and recording data in the recording medium using the calculated optimum record power.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1A˜1B show a plurality of record layers contained in a recording medium according to the present invention;

FIG. 2 is a conceptual diagram illustrating a method for assigning an OPC (Optimum Power Control) area to respective record layers contained in a recording medium in accordance with a first preferred embodiment of the present invention;

FIG. 3 is a conceptual diagram illustrating a method for assigning an OPC area to respective record layers contained in a recording medium in accordance with a second preferred embodiment of the present invention;

FIG. 4 is a conceptual diagram illustrating a method for assigning an OPC area to respective record layers contained in a recording medium in accordance with a third preferred embodiment of the present invention;

FIG. 5 is a conceptual diagram illustrating a method for assigning an OPC (Optimum Power Control) area to respective record layers contained in a recording medium in accordance with a fourth preferred embodiment of the present invention;

FIG. 6 is a conceptual diagram illustrating a method for recording management information capable of managing an OPC area contained in a recording medium according to the present invention;

FIG. 7 is a block diagram illustrating an optical recording/reproducing device for recording/reproducing data in/from a recording medium according to the present invention;

FIG. 8 is a flow chart illustrating a method for recording data in a recording medium according to the present invention; and

FIG. 9 is a flow chart illustrating a method for establishing an OPC area in a recording medium, and a method for recording data in the recording medium according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A recording medium, and a method and apparatus for recording data in the recording medium according to the present invention will hereinafter be described with reference to the annexed drawings.

Prior to describing the present invention, it should be noted that most terms disclosed in the present invention correspond to general terms well known in the art, but some terms have been selected by the applicant as necessary and will hereinafter be disclosed in the following description of the present invention. Therefore, it is preferable that the terms defined by the applicant be understood on the basis of their meanings in the present invention.

A recording medium for use in the present invention is indicative of all recordable mediums, for example, an optical disc, and a magnetic tape, etc., according to various recording schemes.

For the convenience of description and better understanding of the present invention, the optical disc, such as a BD, will hereinafter be exemplarily used as the above-mentioned recording medium in the present invention. It should be noted that technical ideas of the present invention can be applied to other recording mediums without departing from the scope and spirit of the invention.

The term “Optimum Power Control (OPC) area” is indicative of a predetermined area assigned to perform an OPC process in the recording medium. The term “Optimum Power Control (OPC)” is indicative of a predetermined process capable of calculating an optimum record power when recording data in a recordable optical disc.

In other words, if the optical disc is seated in a specific optical recording/reproducing device, the optical recording/reproducing device repeatedly performs a predetermined process for recording data in the OPC area of the optical disc, and reproducing the recorded data, such that it calculates an optimum record power applicable to the optical disc. Thereafter, the optical recording/reproducing device uses the calculated optimum record power when recording data in the optical disc. Therefore, the OPC area is always required for the recordable optical disc.

The term “Multi-layer” is indicative of at least two record layers. If a multi-layer includes two record layers, this configuration is referred to as a dual-layer. If a multi-layer includes only one record layer, this configuration is referred to as a single-layer. If a multi-layer includes the dual-layer, physical characteristics of respective layers of the dual-layer are different from each other, such that respective layers require their unique OPC areas. Specifically, the present invention can be effectively used for a multi-layered disc composed of at least three record layers.

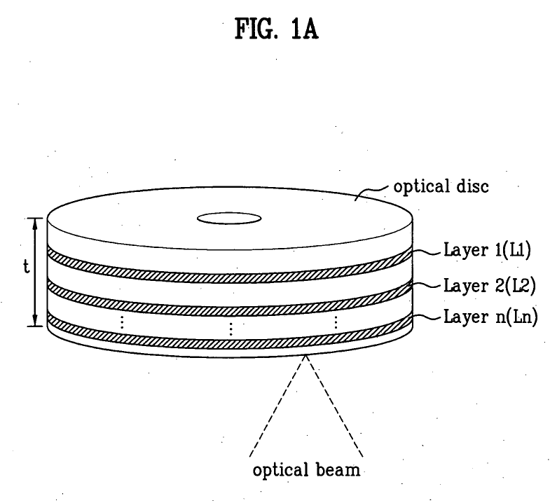

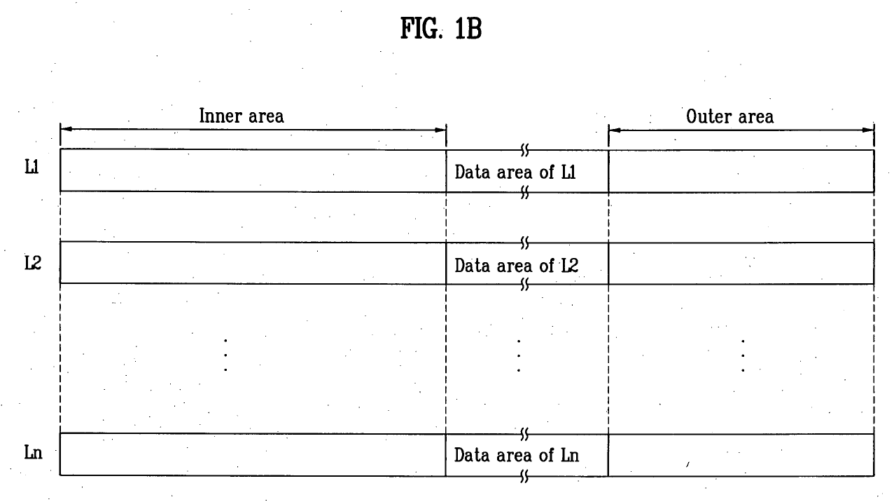

FIGS. 1A˜1B show a recording medium capable of recording data therein, for example, a multi-layered BD-R and a multi-layered BD-RE, according to the present invention.

Referring to FIG. 1A, a disc of the present invention includes N record layers. A first record layer (Layer 1, L1), a second record layer (Layer 2, L2), and an N-th record layer (Layer N, Ln) are arranged to be sequentially spaced apart from an optical-beam incidence location. Needless to say, the first record layer (L1), the second record layer (L2), and the N-th record layer (Ln) may be arranged to be sequentially closed to the optical-beam incidence location, such that the present invention is not limited to the aforementioned examples and is also applicable to other examples if required. In association with the above-mentioned description, although there is no limitation in the number of record layers contained in an optical disc, the number of record layers maximally allowed in a single optical disc in consideration of a general optical-disc thickness (t) of about 1.2 mm is generally set to 8.

For the convenience of description, a cross-sectional view of the optical disc is shown in FIG. 1B. Respective record layers (L1, L2, . . . , Ln) are classified into an inner area, a data area, and an outer area on the basis of a disc inner area. Each of the inner area and the outer area includes the OPC area and an area for recording a variety of management information. The data area stores user-desired data. In association with the above-mentioned description, the data area may further include a spare area for performing defect management.

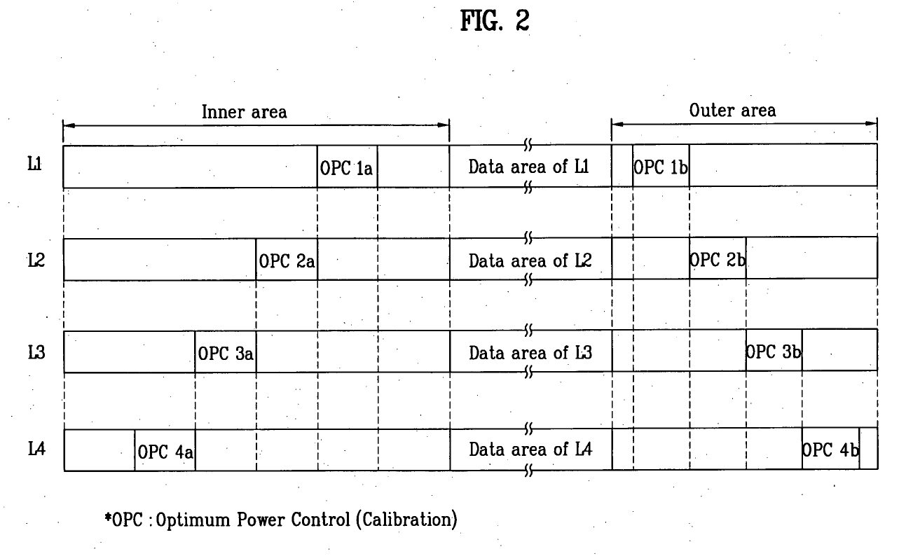

FIGS. 2˜5 show conceptual diagrams illustrating a variety of methods for assigning an OPC (Optimum Power Control) area to respective record layers contained in a recording medium in accordance with first to fourth preferred embodiments of the present invention. In association with the above-mentioned description, although a multi-layered disc composed of 4 record layers is shown in FIGS. 2˜5 for the convenience of description. It is obvious to those skilled in the art that the methods and structures for assigning the OPC area according to the first to fourth preferred embodiments are equally applied to the multi-layered disc composed of N record layers.

In association with the above-mentioned description, according to the first to fourth preferred embodiments of the present invention, although the OPC area is contained in all record layers, an OPC area of one record layer and another OPC area of a neighboring record layer are not arranged at the physically same locations with respect to optical beam. In other words, a variety of power values from a high power value to a low power value are sequentially used to perform the OPC process. If OPC areas are arranged at the physically same positions with respect to optical beam between at least two record layers adjacent to each other, the possibility of incurring optical-beam interference in a predetermined range from an actually-used OPC area to an OPC area of a neighboring record layer is increased, such that the increased possibility of the optical-beam interference may have a negative influence in calculating an optical record power in light of an OPC-area purpose associated with the calculation of the optimum record power.

Although the aforementioned first to fourth preferred embodiments disclose a variety of methods for assigning the OPC area to each of the inner and outer areas according to the same scheme, it should be noted that any one of the inner and outer areas may include the OPC area, or each of the inner and outer areas includes the OPC area, such that the OPC area may be contained in respective inner and outer areas as necessary. For example, the first preferred embodiment may be applied to the inner area, and the second preferred embodiment may be applied to the outer area.

FIG. 2 is a conceptual diagram illustrating a method for assigning an OPC (Optimum Power Control) area to respective record layers contained in a recording medium in accordance with a first preferred embodiment of the present invention. The higher the number of record layers, the longer the distance between the OPC area and the data area.

Referring to FIG. 2, OPC areas 1a˜1b adjacent to the data area are assigned to the first record layer L1. An OPC area 2a and an OPC area 2b are assigned to the second record layer L2. In the case of the inner area, the OPC area 2a is not physically overlapped with the OPC areas 1a˜1b contained in the first record layer L1, and is arranged to be closer to the inner area as compared with the OPC area 1a. In the case of the outer area, the OPC area 2b is arranged to be closer to the outer area as compared with the OPC area 1b. If the OPC areas are assigned to four record layers using the aforementioned method, the configuration shown in FIG. 2 is constructed. In the meantime, the OPC area of the outer area according to the first preferred embodiment gradually moves from the outermost area to the innermost area, such that it can be assigned to respective record layers.

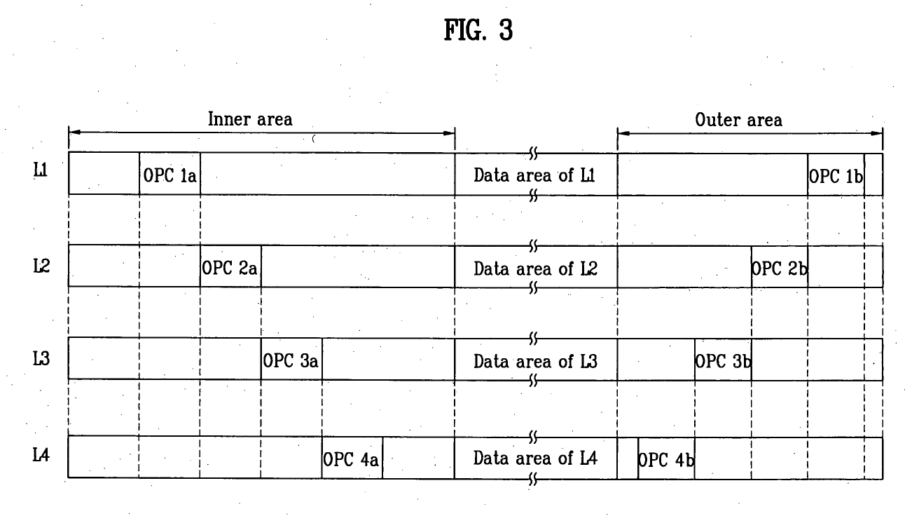

FIG. 3 is a conceptual diagram illustrating a method for assigning an OPC area to respective record layers contained in a recording medium in accordance with a second preferred embodiment of the present invention. The higher the number of record layers, the shorter the distance between the OPC area and the data area.

Referring to FIG. 3, OPC areas 4a˜4b adjacent to the data area are assigned to the fourth record layer L4 indicative of the last record layer. An OPC area 3a and an OPC area 3b are assigned to the third record layer L3. In the case of the inner area, the OPC area 3a does not physically overlap with the OPC areas 4a˜4b contained in the fourth record layer L4, and is arranged to be closer to the inner area as compared with the OPC area 4a. In the case of the outer area, the OPC area 3b is arranged to be closer to the outer area as compared with the OPC area 4b. If the OPC areas are assigned to four record layers using the aforementioned method, the configuration shown in FIG. 3 is constructed. In the meantime, the OPC area of the outer area according to the second preferred embodiment gradually moves from the innermost area to the outermost area, such that it can be assigned to respective record layers.

In association with the above-mentioned description, the first preferred embodiment shown in FIG. 2 and the second preferred embodiment shown in FIG. 3 are characterized in that OPC areas of all record layers including the neighboring record layer are not overlapped with each other. Therefore, the first and second preferred embodiments can minimize interference between OPC areas, whereas a large amount of disc volume is required to perform the allocation of the OPC areas.

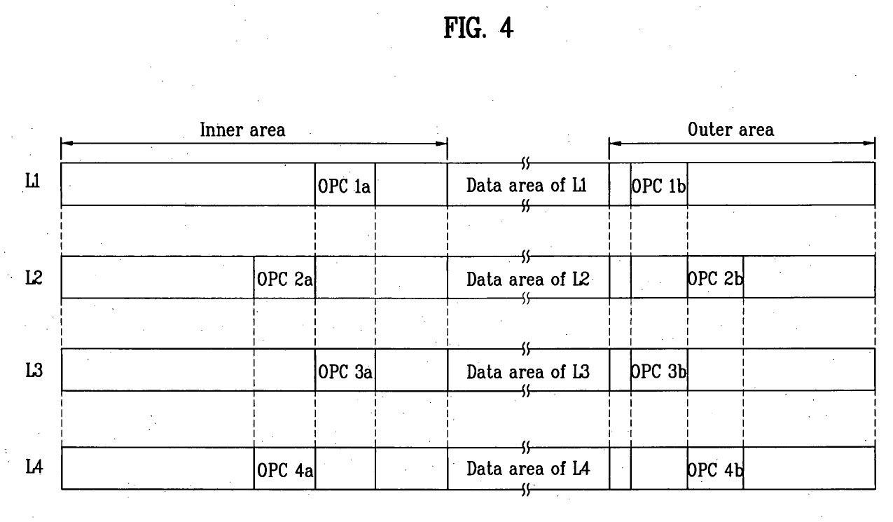

FIG. 4 is a conceptual diagram illustrating a method for assigning an OPC area to respective record layers contained in a recording medium in accordance with a third preferred embodiment of the present invention. In more detail, FIG. 4 shows an exemplary structure in which OPC areas of neighboring record layers are not physically overlapped with each other, but other OPC areas of other record layers other than the neighboring record layers are overlapped with each other. The aforementioned structure shown in FIG. 4 may be referred to as a zig-zag allocation structure.

In more detail, OPC areas 1a˜1b are assigned to the first record layer L1. OPC areas 2a˜2b are assigned to a specific position of the second record layer L2, such that the OPC areas 2a˜2b are not physically overlapped with the OPC areas 1a˜1b of the first record layer L1 at the specific position. OPC areas 3a˜3b are assigned to a specific position of the third record layer L3, such that they are physically overlapped with the OPC areas 1a˜1b of the first record layer L1 at the specific position. OPC areas 4a˜4b are assigned to a specific location of the fourth record layer, such that they are physically overlapped with the OPC areas 2a˜2b of the second record layer L2 at the specific position. Therefore, according to the aforementioned structure shown in FIG. 4, OPC areas of neighboring record layers are not physically overlapped with each other, but other OPC areas of other record layers other than the neighboring record layers are overlapped with each other.

In association with the above-mentioned description, the above-mentioned third preferred embodiment shown in FIG. 4 allows OPC areas of only the neighboring record layers not to be overlapped with each other. Therefore, compared with the first and second preferred embodiments shown in FIGS. 2˜3, the third preferred embodiment shown in FIG. 4 is unable to completely remove interference between OPC areas, although it does not require a large amount of disc volume to perform allocation of the OPC areas. However, if there is no overlapping of the OPC areas of the first and second record layers, although the OPC areas of the first and second record layers are overlapped with each other, a current optical system may have no problem associated with interference caused by the aforementioned overlapping of the OPC areas.

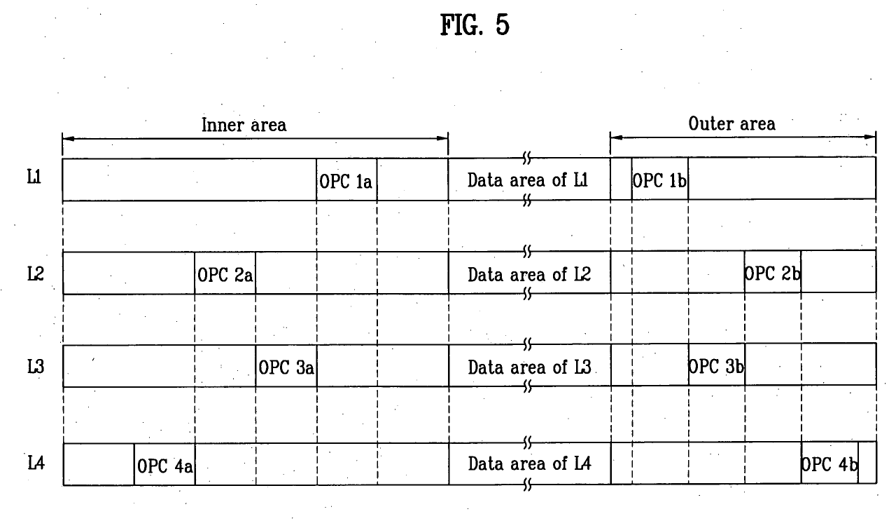

FIG. 5 is a conceptual diagram illustrating a method for assigning an OPC (Optimum Power Control) area to respective record layers contained in a recording medium in accordance with a fourth preferred embodiment of the present invention. In more detail, FIG. 5 shows an exemplary structure in which OPC areas of respective record layers can be freely allocated on the condition that there is no overlapping of OPC areas of neighboring record layers. The aforementioned structure shown in FIG. 5 is referred to as a random allocation structure.

In more detail, OPC areas 1a˜1b are assigned to the first record layer L1. OPC areas 2a˜2b are assigned to a specific position of the second record layer L2, such that they are not physically overlapped with the OPC areas 1a˜1b of the first record layer L1. OPC areas 3a˜3b are assigned to a specific position of the third record layer L3, such that they are not physically overlapped with the OPC areas 2a˜2b of the second record layer L2 at the specific position. OPC areas 4a˜4b are assigned to a specific location of the fourth record layer L4, such that they are not physically overlapped with the OPC areas 3a˜3b of the third record layer L3 at the specific position.

In association with the above-mentioned description, the above-mentioned fourth preferred embodiment shown in FIG. 5 allows OPC areas to be overlapped with each other in neighboring record layers only, and is characterized in that such OPC areas are assigned to respective record layers at random. Therefore, the fourth preferred embodiment shown in FIG. 5 can more freely standardize the structure in which OPC areas are assigned to respective record layers as compared with the first to third preferred embodiments shown in FIGS. 2˜4. In other words, the degree of freedom of the fourth preferred embodiment is higher than those of the first to third preferred embodiments.

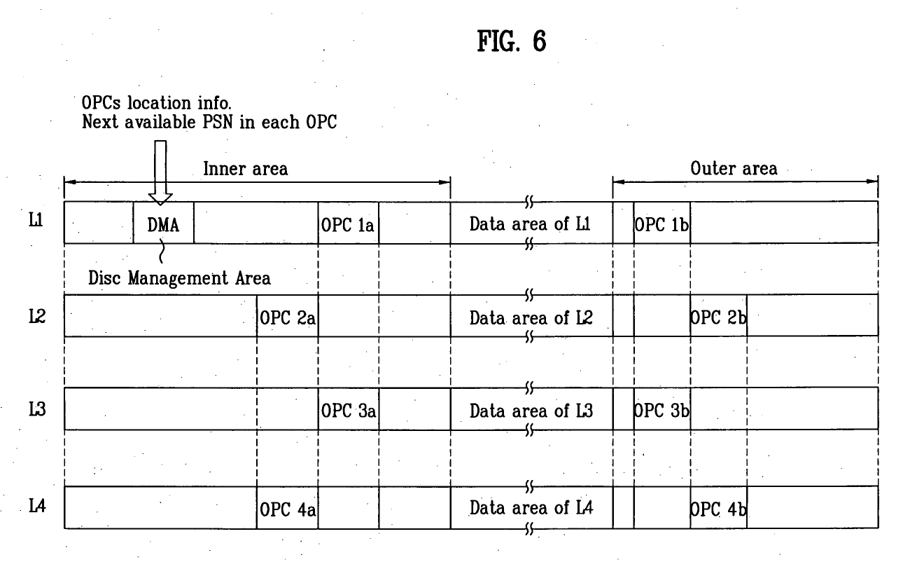

FIG. 6 is a conceptual diagram illustrating a method for recording management information capable of managing an OPC area contained in a recording medium according to the present invention. In more detail, the inner area and/or the outer area of the optical disc include(s) a DMA (Disc Management Area or Defect Management Area) for recording disc management information, and management information of the OPC areas is recorded in the DMA.

In association with the above-mentioned description, management information of the OPC areas may include OPC-area position information of respective record layers contained in a multi-layered disc, for example, “OPCs Location Info” indicative of start and/or end addresses, and “Next Available PSN in each OPC” indicative of a current available position in respective OPC areas. Therefore, if a disc is seated in an optical recording/reproducing device, the optical recording/reproducing device reads OPC-area management information from the DMA, and recognizes position information of the OPC area of the disc and other position information of an available OPC area of the disc, such that the OPC process can be performed at the recognized positions.

Respective OPC areas shown in the aforementioned first to fourth preferred embodiments are assigned by a manufacturer or author of the disc when the disc is manufactured. Although the aforementioned “OPC Location Info” may be pre-defined by the disc author, it is not limited to the aforementioned example of the present invention. For example, the optical recording/reproducing device may select one of the aforementioned preferred embodiments, or may select another one from among the preferred embodiments when the optical disc is formatted. Therefore, the “OPC Location Info” of each OPC area assigned to a corresponding record layer is prescribed to be suitable for an allocated-area position. Specifically, since a fixed OPC area has a fixed position at all times, the aforementioned “OPC Location info” is no longer required. However, if the position of the corresponding area is variable, the necessity of the “OPC Location Info” is increased.

If the OPC area can be established whenever the disc is formatted, the “Next Available PSN” may not be indicative of a fixed value. In other words, since test data recorded in the OPC area may be formatted during the aforementioned disc format process, the “Next Available PSN” acquired after the disc format process is completed may be indicative of a start address and/or an end address of the “OPC Location Info”, but position information of the OPC area may be changed whenever the format process is executed. Therefore, if the aforementioned format process is executed, the aforementioned “Next Available PSN” is compared with an initial “Next Available PSN” acquired after a previous format process has been executed, such that it may be changed to another value.

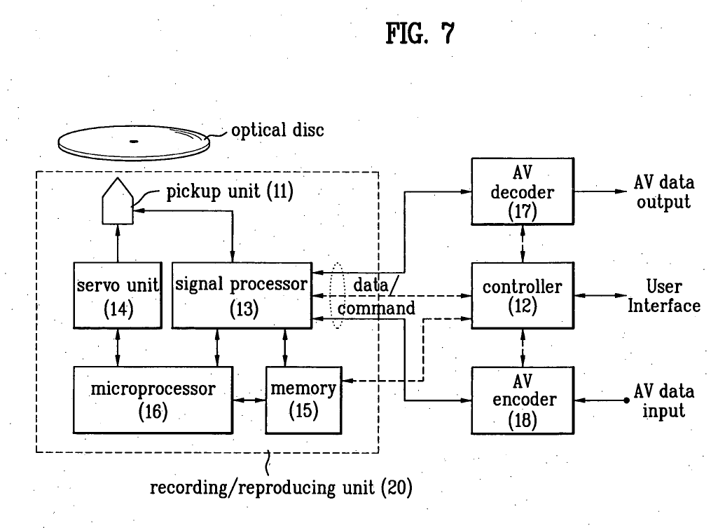

FIG. 7 is a block diagram illustrating an optical recording/reproducing device for recording/reproducing data in/from a recording medium according to the present invention.

The optical recording/reproducing device shown in FIG. 7 includes a record/reproduction unit 20 and a controller 12 for controlling the recording/reproducing unit 20.

Specifically, the recording/reproducing unit 20 includes a pickup unit 11, a servo unit 14, a signal processor 13, a memory 15, and a microprocessor 16. The pickup unit 11 directly records data in an optical disc, and reads data recorded in the optical disc. The signal processor 13 receives a reproduction signal from the pickup unit 11, restores the received reproduction signal to a desired signal value, or modulates a signal to be recorded into another signal recorded in the optical disc, such that it transmits the recovered or modulated result. The servo unit 14 controls operations of the pickup unit 11, such that the pickup unit 11 correctly reads a desired signal from the optical disc, or correctly records the desired signal in the optical disc. The memory 15 temporarily stores both disc management information including OPC-area management information and other data. The microprocessor 16 controls overall operations of the above-mentioned components contained in the recording/reproducing unit. In association with the above-mentioned description, it is well known in the art that the optical recording/reproduction device composed of only the aforementioned recording/reproducing unit 20 is referred to as a drive, and is also applicable to peripheral devices of a computer.

A controller 12 controls all the constituent components shown in FIG. 7. Specifically, the controller 12 receives a user command by interfacing with a user according to the present invention, and transmits record/reproduction commands for recording/reproducing data in/from data in the optical disc to the recording/reproducing unit 20.

A decoder 17 finally decodes a signal read from the optical disc upon receiving a control signal from the controller 12, restores the decoded signal to desired information, such that the restored result is transmitted to the user.

An encoder 18 converts an input signal into a specific format signal (e.g., an MPEG2 transport stream) upon receiving a control signal from the controller 12, and transmits the converted result to the signal processor 13, such that it can record a desired signal in the optical disc.

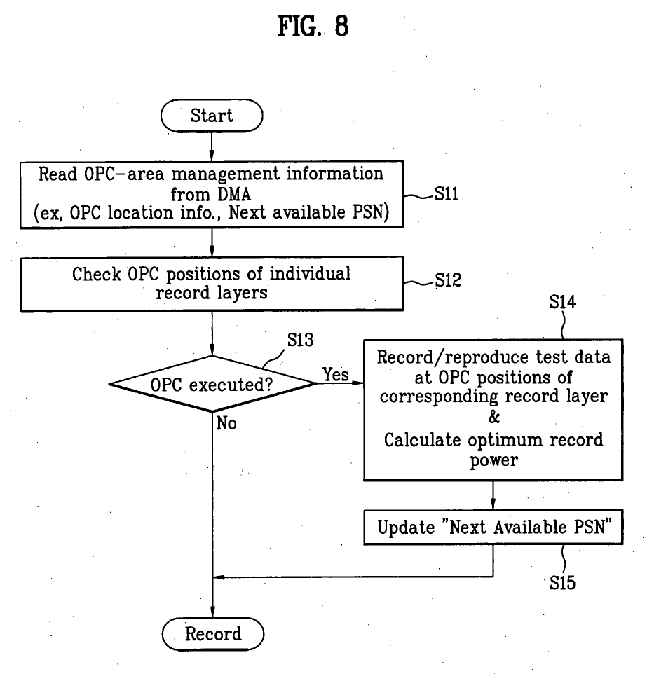

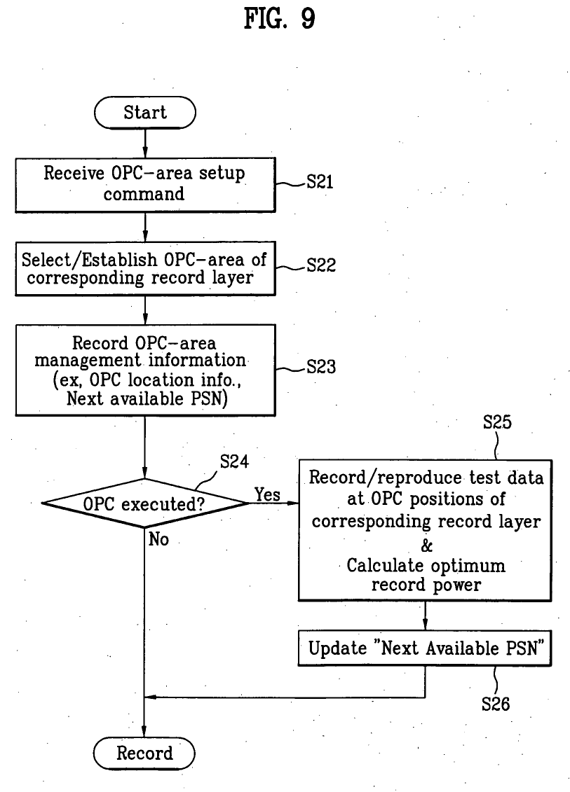

In association with the above-mentioned description, a method for recording data in a recording medium using the above-mentioned optical recording/reproducing device will hereinafter be described with reference to FIGS. 8˜9. FIG. 8 shows an example in which OPC areas are fixed by a disc author as they are assigned by the disc author. FIG. 9 shows an example in which an optical recording/reproducing device variably assigns OPC areas.

Referring to FIG. 8, if a multi-layered optical disc equipped with a physical structure including any one of OPC areas shown in FIGS. 2˜5 is loaded in the optical recording/reproducing device, the microprocessor 16 contained in the recording/reproducing unit 20 controls the pickup unit 11 using the servo unit 14, reads OPC-area management information (e.g., “OPC Location Info”, and “Next Available PSN”) recorded in the DMA of the loaded optical disc at step S11, and temporarily stores the read information in the memory 15. Thereafter, the microprocessor 16 recognizes a correct position at which the OPC process is to be executed by referring to the aforementioned OPC-area management information at step S12. Upon receiving a command for performing the OPC process at step S13, the microprocessor 16 performs the OPC process at the position confirmed by the aforementioned management information, and calculates an optimum record power to be applied to the loaded optical disc at step S14. After performing the above step S14, the microprocessor 16 updates the aforementioned “Next available PSN” information acting as management information associated with the next OPC position at step S15.

Thereafter, upon receiving a record command for a corresponding disc from the controller 12, the recording/reproducing unit 20 performs the received record command using the calculated optimum record power.

Referring to FIG. 9, if a multi-layered optical disc to which an OPC area is not allocated is loaded in the optical recording/reproducing device, the microprocessor 16 contained in the recording/reproducing unit 16 receives an OPC-area setup command associated with the disc at step S21. Thereafter, the microprocessor 16 selects OPC areas of respective record layers, and sets the selected OPC areas at step S22. Specifically, the aforementioned selection/setup process of the OPC-area positions at step S22 may be determined according to any one of methods shown in FIGS. 2˜5. In this case, it should be noted that OPC areas of at least two neighboring record layers are not arranged at the physically same positions with respect to optical beam. If the aforementioned setup process is completed, the established OPC-area management information (e.g., “OPC Location Info”, and “Next Available PSN”) is recorded in a disc management information record layer (e.g., a DMA) at step S23.

Thereafter, upon receiving a command for performing an OPC process at step S24, the microprocessor 16 performs the OPC process at the position confirmed by the above-mentioned management information, and calculates an optimum record power to be applied to the loaded optical disc at step S25. After performing the above step S25, the microprocessor 16 updates the aforementioned “Next available PSN” information acting as management information associated with the next OPC position at step S26.

Thereafter, upon receiving a record command for a corresponding disc from the controller 12, the recording/reproducing unit 20 performs the received record command using the calculated optimum record power.

In association with the above-mentioned description, it is well known to those skilled in the art that steps S21˜S23 of FIG. 9 can be performed in a different way from steps S24˜S26. In other words, there is no need to successively perform steps S24˜S26 after the OPC-area setup process is completed by steps S21˜S23. For example, the OPC process may be performed at steps S11˜S15 of FIG. 8 after the lapse of a predetermined period of time.

As apparent from the above description, a physical structure including an OPC area of a recording medium, and a method and apparatus for recording/reproducing data in/from the recording medium using the physical structure according to the present invention can be effectively used when a multi-layered BD is manufactured, such that data of the disc can be effectively recorded/reproduced.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A recording medium including at least two record layers, each of which includes an inner area, a data area, and an outer area, comprising;
at least one Optimum Power Control (OPC) area contained in at least one of the inner and outer areas,
wherein respective OPC areas contained in neighboring record layers are not arranged at the physically same positions with respect to an optical beam.

2. The recording medium according to claim 1, wherein all OPC areas assigned to the record layers are not arranged at the physically same positions with respect to an optical beam.

3. The recording medium according to claim 2, wherein the OPC areas assigned to respective record layers are sequentially spaced apart from the data area.

4. The recording medium according to claim 2, wherein the OPC areas assigned to respective record layers are sequentially closed to the data area.

5. The recording medium according to claim 1, wherein:
OPC areas assigned to an N-th record layer and an (N+2)-th record layer are arranged at the physically same positions with respect to an optical-beam, and
OPC areas assigned to an (N+1)-th record layer and an (N+3)-th record layer are arranged at the physically same positions with respect to an optical beam,
such that allocation of all OPC areas is performed according to a zig-zag scheme.

6. The recording medium according to claim 1, wherein the OPC areas assigned to respective record layers are assigned at random.

7. The recording medium according to claim 1, further comprising:
a management information area included in at least one of the inner and outer areas, such that it stores management information for managing the assigned OPC areas.

8. The recording medium according to claim 7, wherein the management information area in which the management information of the OPC areas is recorded is a DMA (Disc Management Area or Defect Management Area).

9. The recording medium according to claim 7, wherein the management information of the OPC areas is indicative of position information of the OPC areas assigned to the record layers.

10. The recording medium according to claim 7, wherein the management information of the OPC areas is indicative of available position information of respective OPC areas.

11. The recording medium according to claim 1, wherein the recording medium is indicative of a BD-RE (Blu-ray Disc Rewritable).

12. The recording medium according to claim 1, wherein the recording medium is a write-once BD-R (Blu-ray Disc Recordable).

13. A method for recording data in a recording medium including a plurality of record layers comprising the steps of:
a) a reading position information of Optimum Power Control (OPC) areas, which are assigned to respective record layers contained in the recording medium such that some OPC areas of neighboring record layers are not arranged at the physically same positions with respect to optical beam;
b) performing an OPC process to calculate an optimum record power in an OPC area confirmed by the read position information; and
c) recording data in the recording medium using the calculated optimum record power.

14. The method according to claim 13, wherein the position information of the OPC areas is recorded in a management area contained in the recording medium.

15. A method for establishing an Optimum Power Control (OPC) area of a recording medium including a plurality of record layers comprising the steps of:
a) receiving a command for establishing OPC areas, assigning respective OPC areas to respective record layers contained in the recording medium, and establishing some OPC areas of neighboring record layers such that they are not arranged at the physically same positions with respect to optical beam; and
b) recording available position information of the OPC areas of respective established record layers in a management area.

16. An apparatus for recording data in a recording medium including a plurality of record layers comprising:
a controller for transmitting a record command; and
a recording/reproducing unit for reading position information of Optimum Power Control (OPC) areas, which are assigned to respective record layers contained in the recording medium such that some OPC areas of neighboring record layers are not arranged at the physically same positions with respect to optical beam; performing an OPC process to calculate an optimum record power in an OPC area confirmed by the read position information; and recording data in the recording medium using the calculated optimum record power.
